(19) United States
(12) Patent Application Publication
(10) Pub. No.: US 2007/0192457 A1
(43) Pub. Date: Aug. 16, 2007

(54) APPARATUS AND METHOD FOR PROVIDING A CUSTOMIZED AND INTERACTIVE PRESENTATION OVER THE INTERNET

(76) Inventor: Thomas Ervin, Bloomfield Hills, MI (US)

Correspondence Address: BELL, BOYD & LLOYD, LLP, P.O. Box 1135, CHICAGO, IL, 60690, US

(21) Appl. No.: 11/461,282

(22) Filed: Jul. 31, 2006

Related U.S. Application Data
(60) Provisional application No. 60/773,929, filed on Feb. 15, 2006.

(51) Int. Cl. G06F 15/173

(52) U.S. Cl. 709/223

(57) ABSTRACT

A system and method for providing a dynamically-generated mortgage presentation, the system includes a first computer having a memory and a processor operatively coupled to the memory, wherein the memory is configured to store a plurality of client information and a plurality of presentation information related to the client information, and wherein the processor is configured to generate a client resource file based on the plurality of client information and the plurality of presentation information. The system further includes a second computer communicatively coupled to the first computer and configured to provide the client resource file and transmit a client link, and a third computer communicatively coupled to the second computer and configured to receive the client link, wherein the third computer displays the client resource file provided by the second computer in response to the client link.

### CROSS REFERENCE TO RELATED APPLICATIONS

This patent application claims priority to U.S. Patent Application No. 60/773,929, filed on Feb. 15, 2006, the disclosure of which is herein incorporated by reference.

### TECHNICAL FIELD

This patent application generally relates to an apparatus and method for providing information to a client, and more particularly, this patent application relates to an apparatus and method for providing a customized client multimedia presentation and delivering the same via the internet.

### BACKGROUND

Conducting financial transactions via the internet is well understood. In recent times, the extent and complexity of these financial transactions have grown from, for example, electronically providing order information and receipts to systems that gather and provide detailed financial information to a client or consumer.

One known system provides for coordinating an electronic credit application between an internet user and a plurality of lending institutions via the internet. The system includes displaying form documents on a web site, and receiving credit data provided through the form documents on the web site. The received application data is, in turn, filtered through loan selection criteria loaded on a special loan processing computer to provide lending institutions with applications meeting pre-defined criteria. The filtered application data is then provided to a plurality of lending institutions, and communication between these lending institutions and the internet user is coordinated. This system simply gathers and supplies information for lending institutions or brokers, but provides little or no information to the client.

Another known system provides a method and system for trading loans in real time by making loan applications, such as home mortgage loan applications, and placing them up for bid by a plurality of potential lenders. The system includes a transaction server that maintains a database of pending loan applications and their statuses. The transaction server allows each party to the loan to search and modify that database consistent with their role in the transaction, by communicating requests to the server from a client device identified with their role. For example, brokers at a broker station can add loan applications, can review the status of loan applications entered by that broker, are notified of lender's bids on their loans, and can accept bids by lenders. Similarly, lenders at a lender station can search the database for particular desired types of loans, can sort selected loans by particular desired criteria, can bid on loan applications, and are notified when their bids are accepted. Broker stations, lender stations, and the transaction server can be coupled using multiple access methods, including internet, intranet, or dial-up or leased communication lines. This system simply gathers loan application information and allows lenders and brokers to interact with the results, but provides little or no information to the client.

Another known system utilizes client information to automatically select and present financial products appropriate for the client. The apparatus includes an input device for inputting client information, financial product information, ancillary data, and decision criteria, a storage device for storing the inputted items, decision making logic circuitry for using the inputted items to select a subset of the financial products, and an output device for preparing a client communication which identifies the subset of the financial products. The output device incorporates a portion of the client information and a portion of the financial products information into the client communication. The method according to one aspect includes inputting the same items, storing these inputted items, using the stored items to select a subset of the financial products, and preparing a client communication which identifies the subsets of the inputted information and incorporates it into the client communication. This system simply gathers client information and automatically provides a static summary of financial products to the client based on the gathered information.

It is desirable to provide an apparatus and system that can be used to gather client information and provide customized financial information. Moreover, it would be desirable to provide a system in which lenders, brokers or other loan originators can interact with the clients to identify and provide financial solutions tailored to satisfy each client's requirements. It would further be desirable to provide a system in which customized financial solutions or presentations can be provided and updated to a client via the internet.

### SUMMARY

This patent provides a loan officer or other banking professional with efficient tools for contacting, promoting interaction and building relationships with potential clients and/or referral sources. These tools allow the loan officer to create and customize multimedia presentations that are tailored to their clients needs. These tools further allow the customized presentations to be dynamically updated and revised as the client's needs change and are further defined.

The patent further provides a system and method that allows the loan officer and the potential client, who are distant from one another, to communicate using both an audio medium, e.g., a telephone conversation, and a visual medium, e.g., a customized website with multimedia content, in place of traditional audio-only communications. These systems and methods provide an efficient and highly-customizable tool for accomplishing this advanced form of communicating. These systems and methods further allow the loan officer to provide a large variety of services and information on the entire home buying or financial planning experience.

In one embodiment, a system for providing dynamically-generated client presentations includes a first computer, a memory and a processor operatively coupled to the memory wherein the memory is configured to store a plurality of client information and a plurality of presentation information such as, for example, multimedia information, related to the client information, and wherein the processor is configured to generate a client resource file based on the plurality of client information and the plurality of presentation information. The system further includes a second computer communicatively coupled to the first computer and configured to provide the client resource file and transmit a client link. The system further includes a third computer communicatively coupled to the second computer and configured to receive the client link, wherein the third computer displays the client resource file provided by the second computer in response to the client link. In another embodiment, the second computer is configured to provide a client web page generated from the client resource file and transmit a client link to a third computer for displaying the client web page.

In another embodiment, an apparatus for providing dynamically-generated client presentations includes a processor, a memory operatively coupled to the processor and configured to store a client presentation program. The client presentation routine includes a client information subroutine configured to receive client information and presentation information related to the client information, a client presentation subroutine configured to generate a client resource file based on the client information and the presentation information such as, for example, multimedia information, a presentation subroutine configured to provide the client resource file and a communications subroutine configured to communicate a client link.

In another embodiment, a method for providing dynamically-generated client presentations includes gathering a plurality of client information, selecting a plurality of presentation information such as, for example, multimedia information, related to the client information, generating a client resource file based on the client information and the presentation information wherein the client resource file has a plurality of user information. The method further includes storing the client resource file on a web server, communicating a client link identifying the stored location of the client resource file and presenting the client resource file in response to a request related to the client link.

Additional features and advantages of the present invention are described in, and will be apparent from, the following Detailed Description and the figures.

### BRIEF DESCRIPTION OF THE FIGURES

FIG. 1 illustrates a network overview of one embodiment of a multimedia client communication process.

FIG. 1A illustrates a flow chart detailing one embodiment of the multimedia client communication process.

FIG. 2 illustrates a flow chart detailing one embodiment of the multimedia client editing process.

FIG. 3 illustrates a flow chart expanding on the multimedia client presentation editing process shown in FIG. 2.

FIG. 4 illustrates a flow chart detailing one embodiment of a referral presentation process.

FIGS. 5 to 16 illustrate screen images of various elements of exemplary client presentation routines according to various embodiments.

FIGS. 17A-17B illustrate a screen images of an embodiment of a client link.

### DETAILED DESCRIPTION

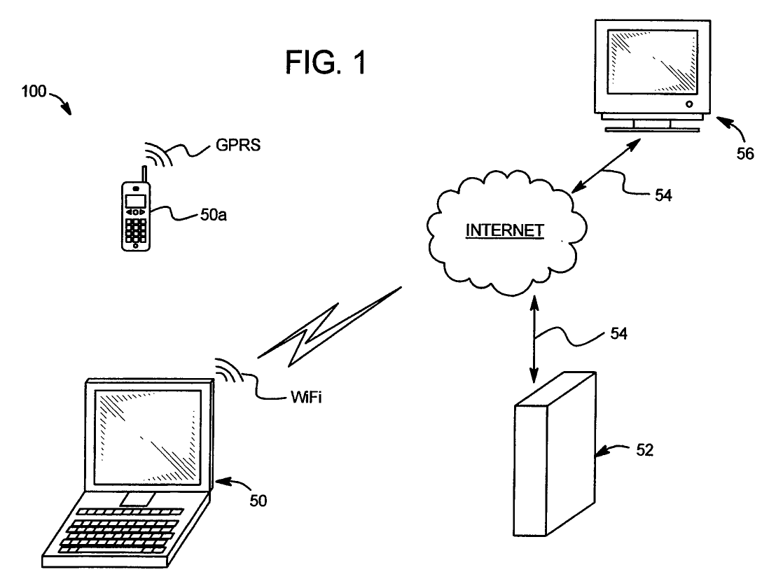

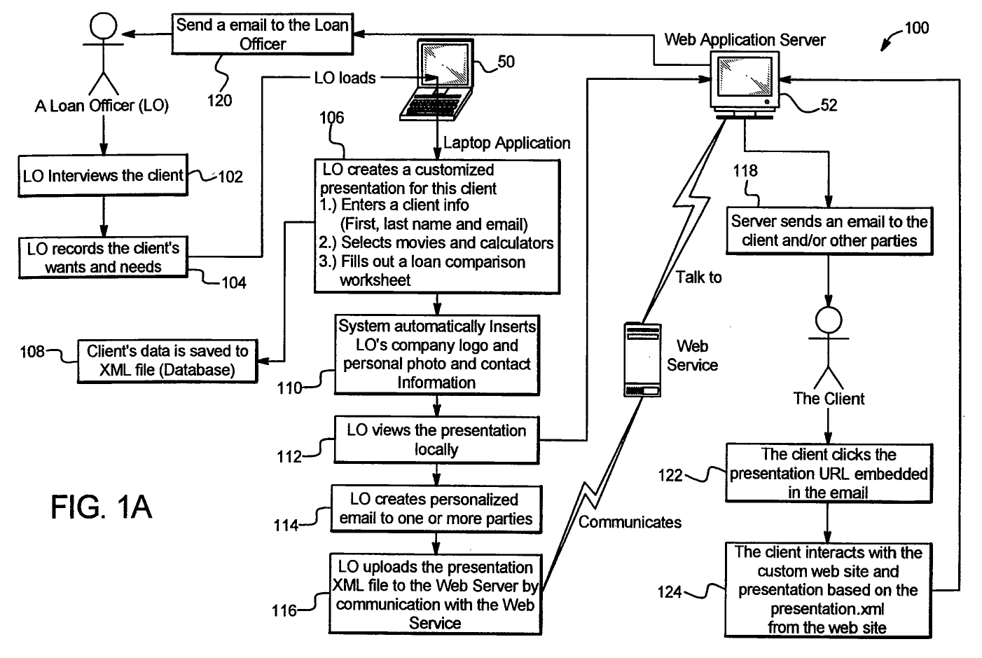

FIG. 1 illustrates a network overview of one embodiment of a multimedia-based client resource and communication system generally indicated by the numeral 100. The multimedia-based client resource system 100, as shown, includes a loan officer (LO) computer 50 communicatively coupled to a web server or host 52. The web server 52 and LO computer 50, in turn, are configured to connect to the internet, an intranet, etc., in any known manner. For example, the LO computer is illustrated having a wireless communication connection (WiFi) while the web server 52 is connected via a network 54. In an alternate embodiment, a personal digital assistant (PDA) 50A can be connected to the internet through a WiFi or cellular connection (GPRS). The web server 52 can be configured to host or serve a multimedia resource to the client. In particular, the multimedia presentation and resource material may be available for interaction through a client computer 56. It will be understood that the resources provided via the multimedia presentation may be stored and available through the web server 52 for an extended period of time. Thus, these resources can be used, and reused, by the client, the client's advisors or friends, etc. throughout the home buying and financial planning experience.

FIG. 1A illustrates a flow chart detailing the operation of one embodiment of the multimedia-based client resource and communication system 100. The multimedia client resource system 100 allows mortgage brokers and mortgage bankers to provide existing and potential clients with a web-based home buying and financial planning resource that facilitates visual and interactive communications between the two parties. For example, the LO can use the client presentation as a basis for interaction and relationship building with the client, and the client can access and utilize the resources provided via the customized, multimedia website throughout their entire home buying and financial planning experience. In other words, the client resource system 100 goes beyond merely providing static mortgage details and options to a client, and allows for the creation of multimedia presentations and a centralized planning resource that is tailored to address the specific needs of each client.

Returning to the flow chart shown in FIG. 1A, the client resource system 100 begins at a block 102 with a loan officer (LO), e.g., the user of the system 100, conducting an interview with a client. It will be understood that the interview may be a face-to-face interview at the LO's office or the client's home or business, but will often be a telephonic interview between the two parties. The LO may gather a variety of client information such as, but not limited to: client name, client contact information, current financial information, financial history information, back ground and education information, employment information and specific loan or mortgage information of interest to the client. The LO may further inquire about the client's experience with home buying, home selling, mortgage evaluation, new home construction, and area or location specific questions or inquires.

At a block 104, the LO can record and store the gathered client information in a database application executed, for example, on the LO computer 50 or personal laptop. The database application can serve to organize the gathered client information into predefined fields, categories and groups. At a block 106, the LO can begin constructing a customized client resource web site or presentation based on the gathered (and organized) client information, requirements and interests. The LO can complete and integrate a loan comparison worksheet that highlights the differences and advantages between various loan and mortgage products that may be of interest to the client.

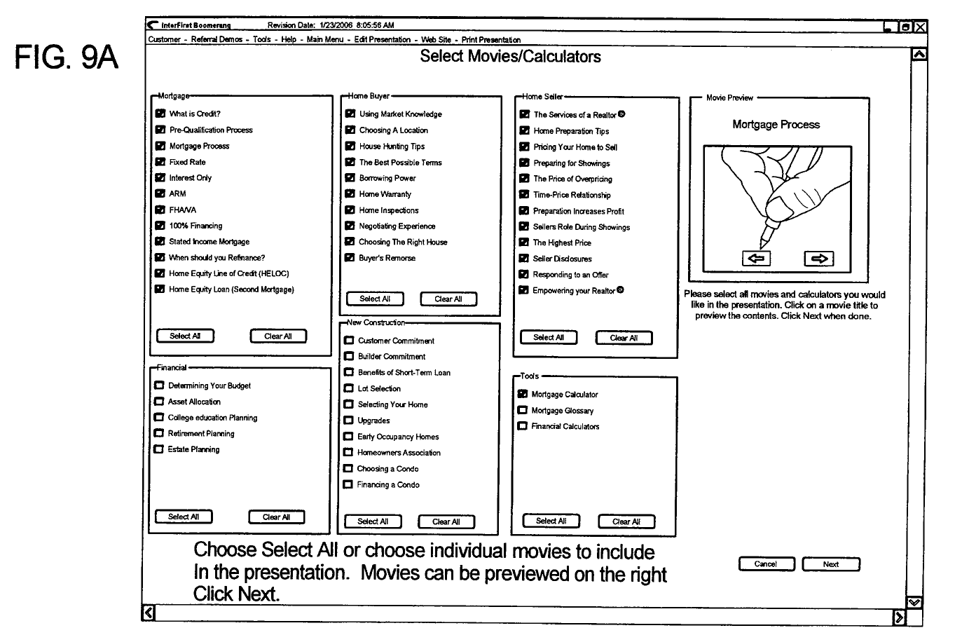

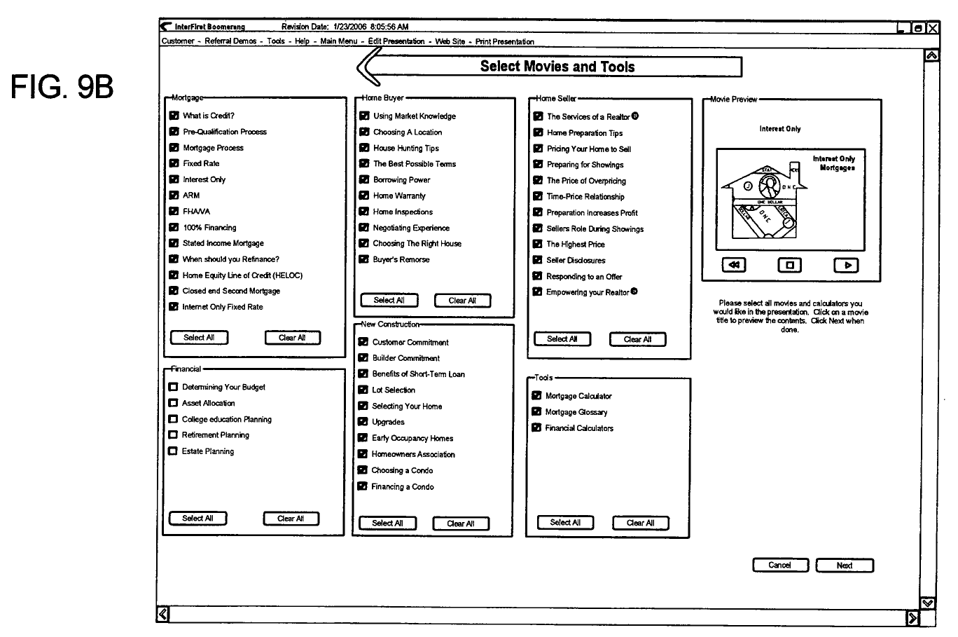

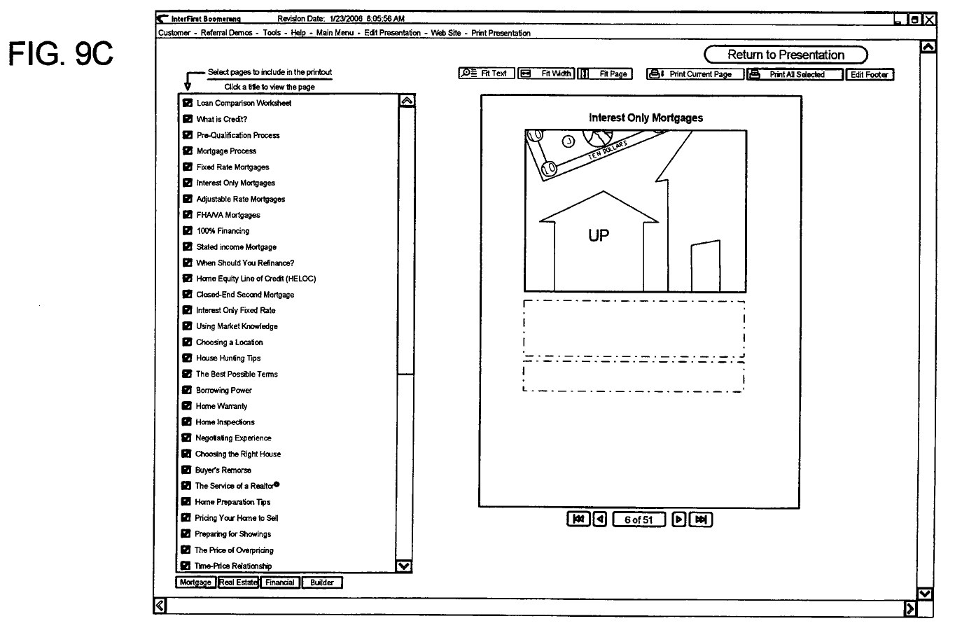

The LO can identify and select presentation information such as, for example, (a) mortgage information, (b) home buying materials, (c) home selling information, (d) financial information, (e) materials and information related to new construction of homes, and (f) financial calculators and tools, (see FIG. 9). The presentation information can include informational video clips that are specially produced to address specific customer interests and needs, and can engage the client's attention utilizing full-stream video, music sound tracks, text and four color graphics. In this way, video clips selected as a part of the presentation information can engage a client's attention at a much higher level than a simple, static brochure or informational flyer.

The presentation information such as (a) mortgage information can include: background material describing the financial concept of credit; the mortgage or loan pre-qualification process; and the mortgage process. The mortgage information can further include: information on various types of mortgage products such as fixed rate; interest only; adjustable rate mortgages (ARM); FHA/VA; 100% financing and stated income mortgages. Supplemental mortgage information can also be provided to inform a client about the possibility of refinancing a mortgage, or applying for a home equity line of credit (HELOC) or a home equity loan (second mortgage).

The presentation information such as (b) home buying materials can include, based on the gathered client information: tips and guides on utilizing market knowledge; selecting a location, house hunting; and receiving the best possible terms. Home buying materials can further encompass information on maximizing and utilizing buying power, selecting and utilizing home inspectors, negotiation techniques, training and tactics; selecting the right house and addressing buyer's remorse. By way of contrast, presentation information can provide (c) home selling information such as, for example: maximizing the service of a realtor; preparing property for sale; pricing the property; the consequences of overpricing; the relationship between the price of the property and the length of time on the market. The selling information can also address issues and questions such as what is the seller's role during a showing, what is the highest price that should be expected, what information should/must be disclosed, how to respond to an offer and how to empower the realtor to work for you.

As previously discussed, the client resource system 100 can be utilized to compile (d) financial information that can be utilized by the client during their planning. For example, selected presentation information or resources can include: discussions and tutorials on preparing a budget; allocating assets; planning for college; retirement planning and estate planning. Selection of these tutorials can be made based on the age, parenting status, i.e., number and age of children, and financial resources of the client.

The presentation materials can further serve as a resource for (e) materials and information related to new construction of homes. For example, the new construction information can include: information on customer and builder commitments; the benefits of taking a short-term loan; selecting a lot; selecting a home and home plan; and drawbacks and benefits of new construction upgrades. Additional resources may be information on early occupancy home, homeowner's associates, or the selection and finance of a condominium.

Additional presentation materials and resources can include (f) financial calculators and tools. These calculators and tools include, but are not limited to, mortgage calculators, a mortgage glossary and financial planning calculators.

Regardless of the information selected and included as a portion of the presentation file, the resulting conglomeration of tools and multimedia information provides the client with valuable materials that can assist in every aspect of the home buying/selling, mortgage process. In many cases, the selected information and resources are presented in an interactive and engaging multimedia format that encourages the client to utilize and absorb the information contained within these resources. Moreover, as discussed below in detail, because this information is stored on and provided by, at least temporarily, the web server 52 as a web-based presentation or website, the client can interact and reuse these resources, and can share them with interested third parties.

Returning to the flow chart of FIG. 1A, at a block 108, the client information and the selected multimedia presentation information can be converted into a client resource file. The client resource file may be an extensible mark-up language (XML) file in which each item of the client information file and each of the identified presentation items are correlated into a predefined file format. For example, the database may contain a document type definition (DTD) file that identifies and organizes the structure and format of the XML client resource file. Thus, when the database information is formatted to create the client resource file, each item is linked to a DTD element that identifies what is contained or represented by that item or item description.

At a block 110, the formatted client presentation information is further augmented with user information specific to the LO and the business to which the LO is affiliated. The user information can include the LO's contact information, the business logo and any other desired company-standard document formats, colors or letterhead.

At a block 112, the XML formatted client presentation information can be combined with a presentation template. The presentation template acts as a framework into which the formatted elements of the client presentation information can be inserted. This framework organizes the look and feel of the presentation to include the information tailored to the client's needs and specific formatting tied to the LO. In this way the LO can quickly and easily create a customized multimedia presentation or presentation web site that promotes interaction and conveys personalized information to each of the LO's clients or potential clients. The LO can further view and interact with the newly created web site via a web browser such as, for example, Microsoft® Internet Explorer® or Mozilla® Firefox®, prior to providing it to the client to gauge its effectiveness and applicability.

At a block 114, the LO creates a personalized message to the client. The message may, for example, include references to their earlier interview, the client presentation and/or information regarding the use of the client presentation. At a block 116, the personalized message and the client presentation are communicated to the web server 52 (web application server) via a web service. Upon completion of the upload of the client presentation to the web server, the personalized message is provided or communicated to the client, as indicated by the reference numeral 118, and a status message is communicated to the LO, as indicated by the reference numeral 120.

At a block 122, the client selects a hyperlink or link automatically appended to the personalized message provided by the web server. Selection of the link, initiates a web browser session and navigates to a web address or internet protocol (IP) address that identifies the storage location of the client presentation on the web server. At a block 124, the client interacts with the custom client presentation via the web browser. As the client interacts with the customized presentation, the client can select links or buttons coupled to FLASH® media presentations such those created by Macromedia Flash® Professional studio distributed by Adobe Systems Incorporated. The worksheets, presentation and media may further include JAVA™ based controls, buttons, or other interactive elements. Regardless of the programming medium utilized in the client presentation, the interactive and multimedia nature of the presentation provides an engaging and interesting experience for the client.

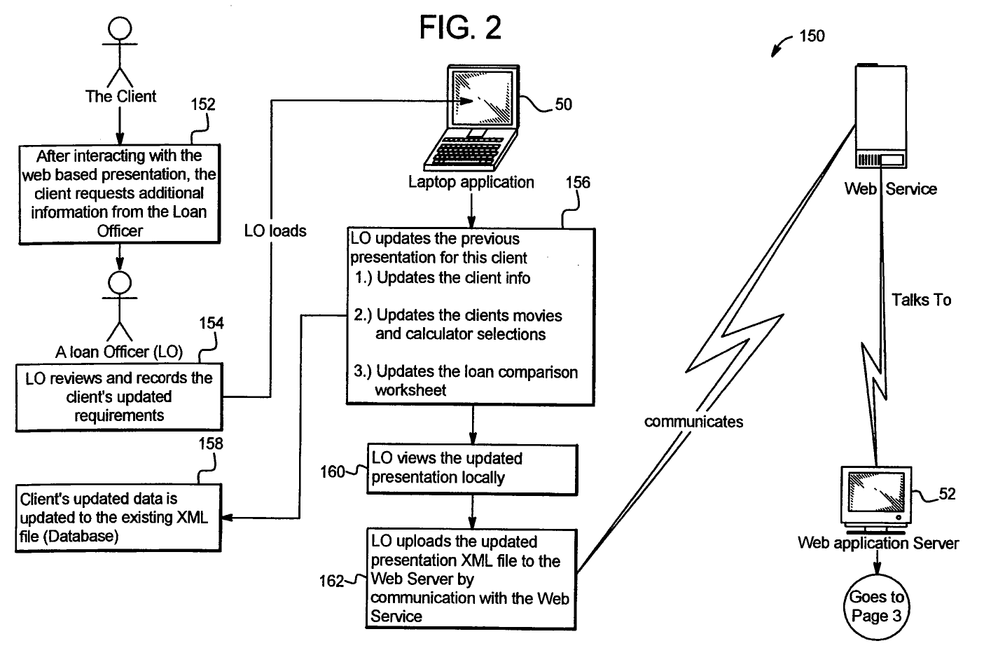

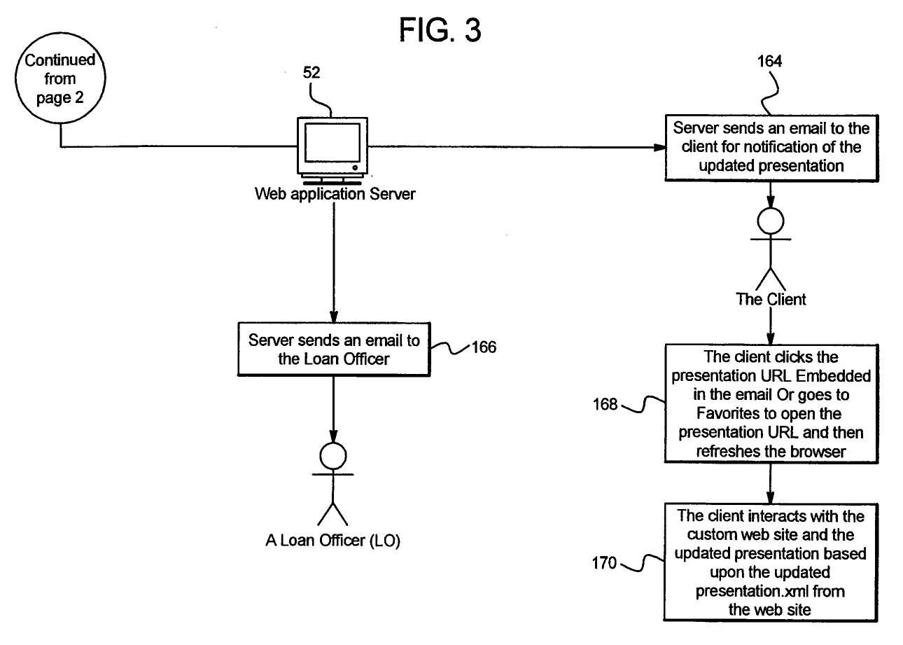

FIGS. 2 and 3 illustrate flow charts detailing one embodiment of a client presentation editing system generally indicated by the numeral 150. The client presentation editing system 150 allows the loan officer and client to interact and dynamically update the client presentation or web site to suit and address the topics of conversation. For example, if during the course of a telephonic conversation, the client requests additional information regarding a mortgage product or financial computation, the LO can identify and select the appropriate information and provide the same via the client presentation hosted on an internet website.

At a block 152, the LO and the client interact to discuss the information provided to the client via the client web site created by the LO and viewed by the client at block 124. It will be understood that this interaction could be conducted via a teleconference, a face-to-face meeting, and any type of electronic communication such as, for example, e-mail, instant messaging (IM) or a web-based video conference. At a block 154, the LO can record and identify additional areas of client interest and focus. These additional areas of interest are, at a block 156, recorded on the LO computer 50 and the appropriate database items are updated. In particular, the client information items and each of the identified presentation items are modified to reflect the LO's understanding of the clients interest and focus. Thus, as the client and the LO interact, additional information, such as multimedia clips, can be provided to the client that supports, clarifies and supplements their discussions, ideas and goals.

At a block 158, the updated client and presentation can be converted into an XML formatted client resource file. As previously discussed in connection with FIG. 1 and the block 108, the updated information can be identified and correlated with a previously prepared DTD file. The resulting updated XML-based client resource file is coupled or merged with a presentation template that can be stored on the LO computer 50, an office network or other connected device. At a block 160, the LO can review and check the merged and updated presentation or web site prior to providing the same to client.

At a block 162, the updated client presentation is communicated to a web application server (web server) via a web service. It will be understood that the LO can be connected to the web service and the web server 52 via a variety of communication channels. For example, the LO can utilize a personal digital assistant (see item 50A in FIG. 1) containing a version of the database or a thin-client that provides access to the database. The PDA 50A may include, among other things, a general packet radio service (GPRS) or a wireless fidelity (WiFi), e.g., IEEE 802.11b wireless networking interface, that allows the PDA 50A to communicate directly with the web server 52 through a wireless network. In this way, the LO can conduct business from virtually any location while providing custom, personalized and dynamic support to their clients.

Referring to FIG. 3, once the updated customized client presentation is fully uploaded to the web server 52, another personalized message or other communication is transmitted to the client, as indicated by the reference numeral 164, and a second status message is communicated to the LO, as indicated by the reference numeral 166.

At a block 168, in one embodiment, the client selects the hyperlink or link provided in the personalized message. Selection of the link, initiates a web browser session and navigates to a web address or internet protocol (IP) address that identifies the client presentation.

At a block 170, the client interacts with the custom client presentation via the web browser. It will be understood that this updating and uploading process between the client and LO may be iterative to allow the client to gain a further understanding of available mortgage products and the related financial concerns and decisions. For example, as shown in FIG. 1, the LO can be communicating with the client and determine that additional presentation information may clarify a client question. By selecting, re-compiling and re-uploading the client resource file and the associated presentation template, an updated web site may be stored on the web server 52 for access by the client. This revision and interaction process can happen continuously, and can allow supplemental customized resources and information to be provided to the client. Moreover, during this iterative process, the LO benefits from the personal interaction with the client which allows a relationship of trust and common goals to be established.

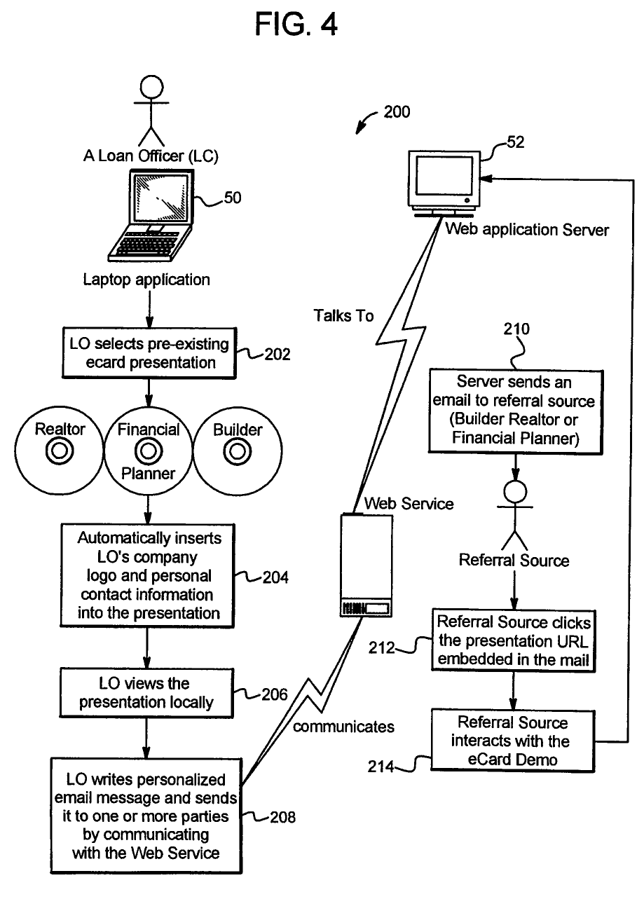

FIG. 4 illustrates a flow chart detailing one embodiment of a referral presentation process generally indicated by the numeral 200. The referral presentation process 200 allows the loan officer to create customized multimedia presentations based on previously established template financial and mortgage presentations. For example, at a block 202, the LO selects one or more of the pre-established templates for their desired referral source. The template could be directed to a realtor, a financial planner and/or a builder and include information, calculators and products that are selected and tailored to satisfy each of their individual needs and requirements. These templates could be stored directly on the LO's laptop or could be stored on a common network drive or resource.

At a block 204, the selected template presentation can be merged with user information specific to the LO and the business to which the LO is affiliated. The user information can include the LO's contact information, the business logo and any other desired company format, colors or letterhead.

At a block 206, the LO can review and check the customized referral presentation prior to providing the same to referral source. At a block 208, the LO can create a personalized message to the potential or existing referral source. The message may, for example, include references to an earlier contact or conversation and a brief explanation of the contents of the presentation, etc. The resulting personalized message and the referral presentation are communicated to a web application server (web server) via a web service. Upon completion of the upload of the client (referral source) presentation to the web server, the personalized message including a hyperlink to the presentation is communicated to the referral source, as indicated by the reference numeral 210.

At a block 212, the referral source can select the hyperlink or link provided in the personalized message. As previously discussed, selection of the link, initiates a web browser session and navigates to a web address or internet protocol (IP) address that identifies the client (referral source) presentation. At a block 214, the referral source interacts with the custom referral presentation via the web browser.

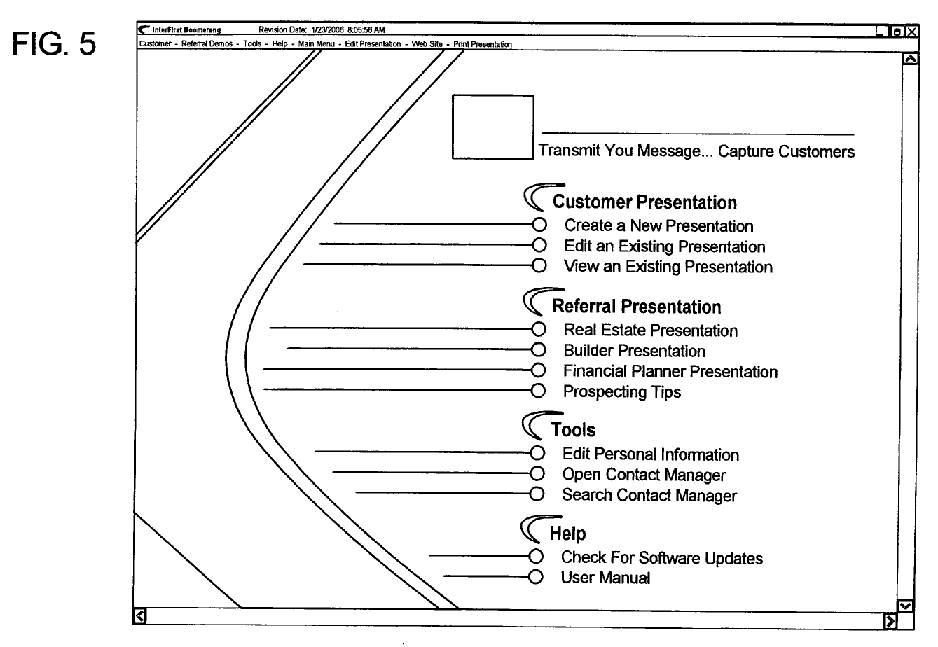

FIGS. 5 to 16 illustrate screen images of various elements of an exemplary client presentation routine. FIG. 5 illustrates an initial screen that divides the functionality of the client presentation routine into categories related to: (i) Customer (client) Presentations; (ii) Referral Presentations; (iii) Tools; and (iv) Help. The Customer Presentation function allows the LO to create, edit and view presentations geared towards loan or mortgage clients. The Referral Presentation function provides for the creation of customized presentations geared towards real estate agents, builders, financial planners and any general prospect or lead. The Tools function allows for the editing of the LO's personal information and the accessing and searching of the LO's contact manager. The Help function provides information and instruction and software updates to assist the LO in utilizing the system.

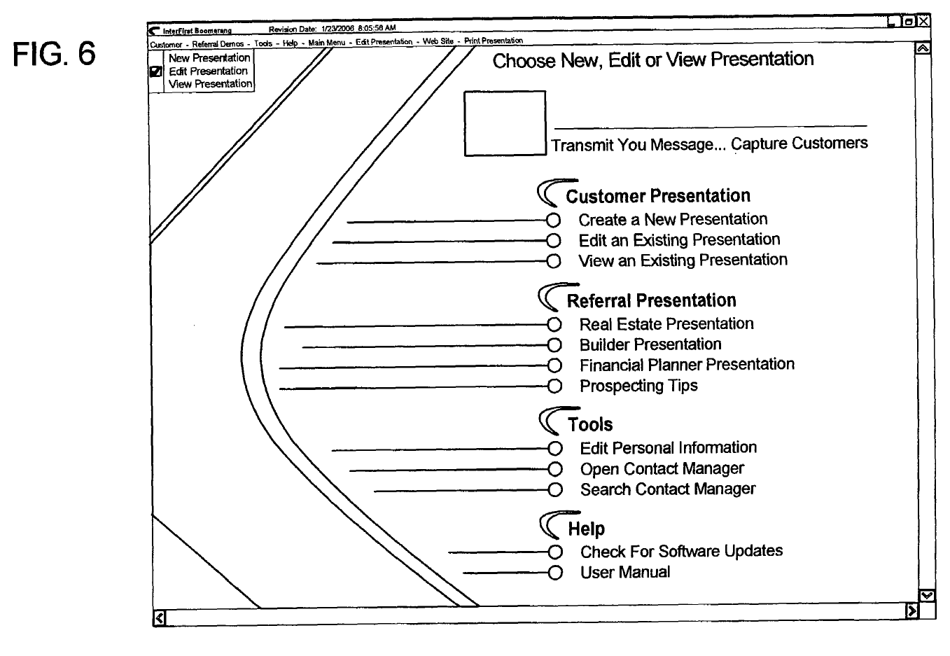

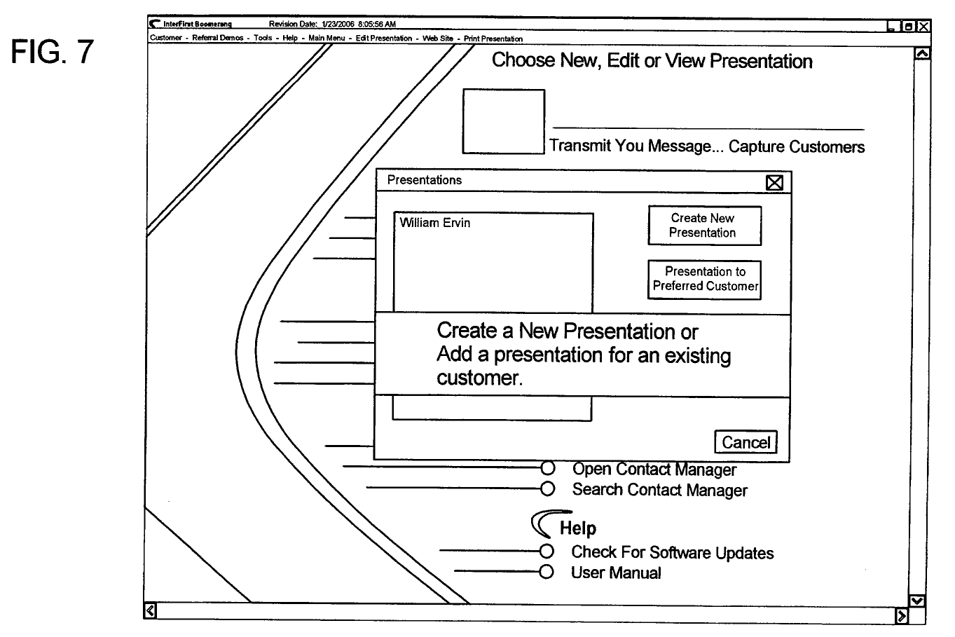

FIG. 6 illustrates the creation of a new customer (client) presentation. FIG. 7 illustrates a dialog box prompting the LO to begin a new presentation or to add a presentation to an existing client.

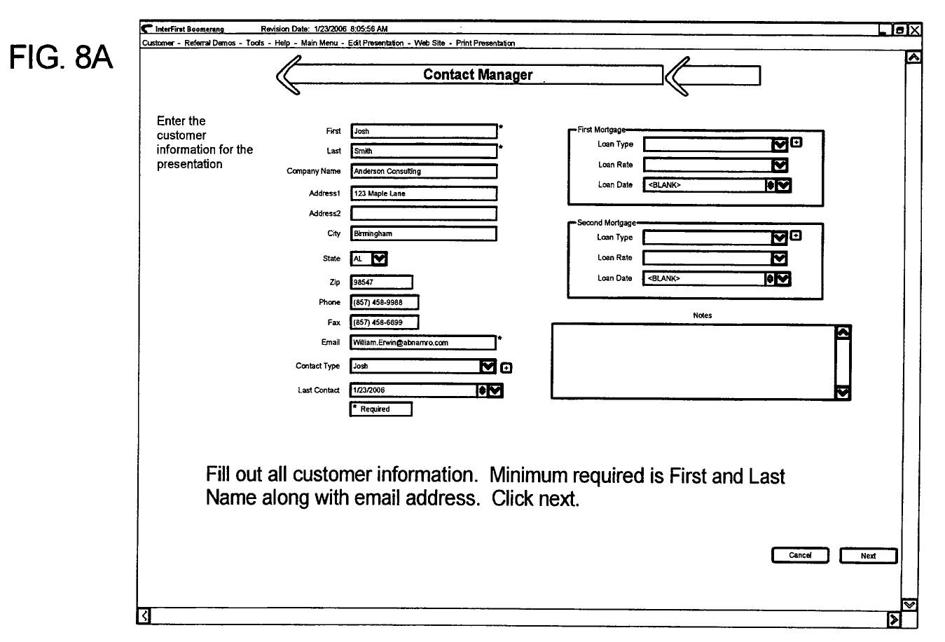

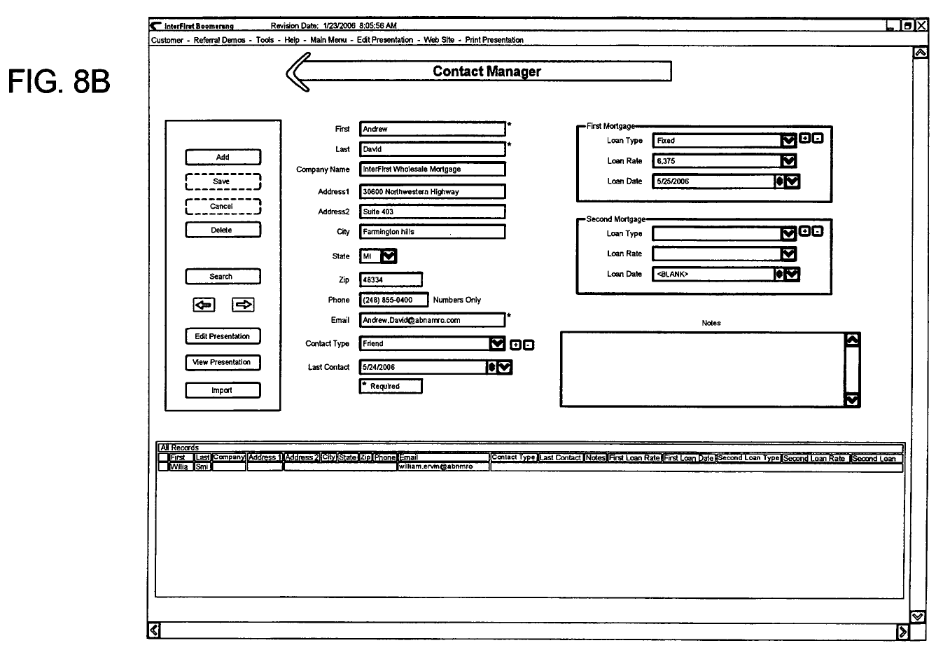

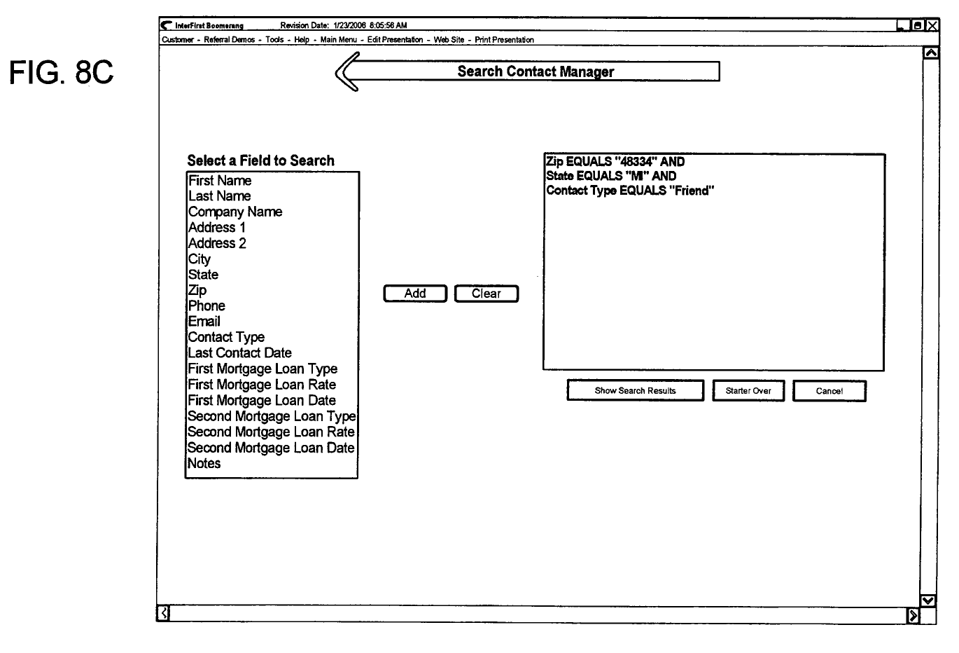

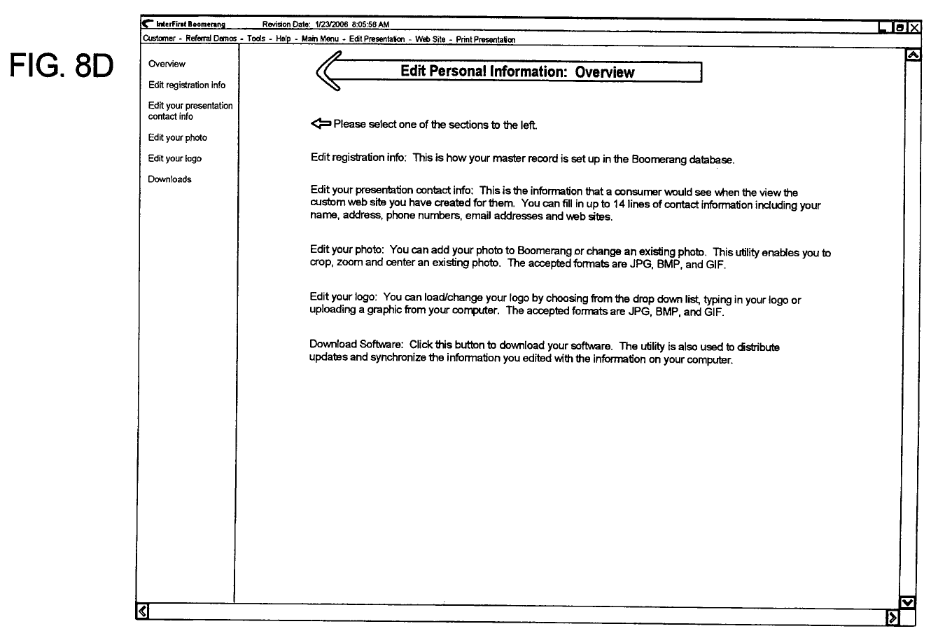

FIGS. 8A-8C illustrate exemplary embodiments of entry stored by a contact manger that can be accessed via the Tools function shown in FIG. 5. The information in the contact manager is generally received during the initial interactions between the LO and the client. This information constitutes all or a portion of the client information discussed above.

FIG. 8D illustrates a selection screen where an overview of editing personal information, such as relating to information in the contact manager, is provided. The contact manager selection can be configured in any suitable manner. For example, a calendar including a functional calendar can be incorporated into this selection. Further, this selection can include an alarm/tickler file and also be configured to allow input of each contact. Additional fields can be added to the contact manager, such as for ‘Birthday’ as well as ‘Spouse Name,’ and add a Loan Amount option in the Search Field of the contact manager can be added.

FIGS. 9A-9B illustrate selection screens in which the LO can identify and select the information pertinent to the client. This information constitutes all or a portion of the presentation information discussed above and, at least, some of which, can be provided in print form as shown in FIG. 9C. This selection can be configured in any suitable manner. For example, the movies can be made more robust; a Mortgage Checklist movie can be created that offers a print option at the end; information needed at Loan application can be provided, such as W2's (2 Years), Self Employed Tax Returns (2 Years), Current Pay Stub(s) (30 days), Residence History (2 years) including landlord information if applicable, Social Security Number(s), Bank Accounts(s)/Investments (2 most recent statements), Divorce Decree (if applicable), Bankruptcy Papers (if applicable), Lease/Rental agreements(s) on Investment Properties, DD214 (VA); movies explaining APR and PMI can be provided; credentials movie for top producing Loan Officers can be provided; introduction movie can be provided that explains what the consumer is looking at and directs them where to click for more content; an AE section can be added that provides the ability to choose certain movies to plug into the presentation; a movie discussing the benefits of buying a second home (e.g., vacation or investment) can be provided; and the like.

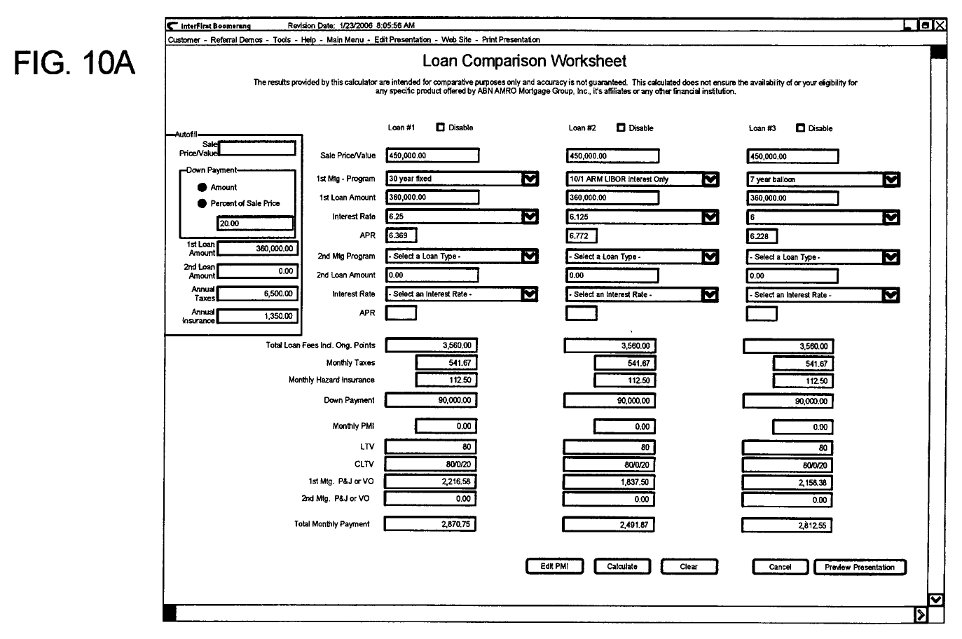

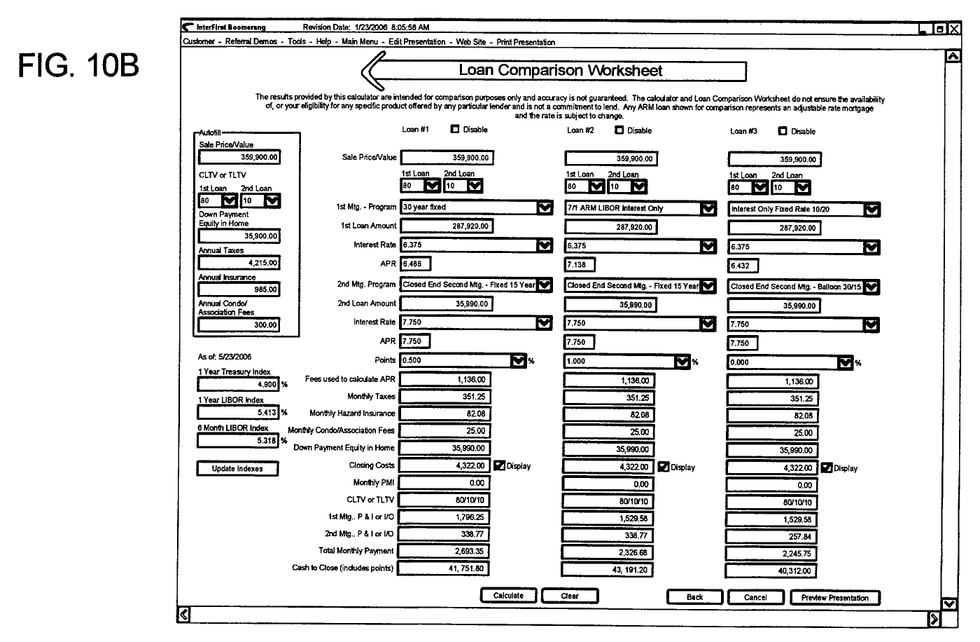

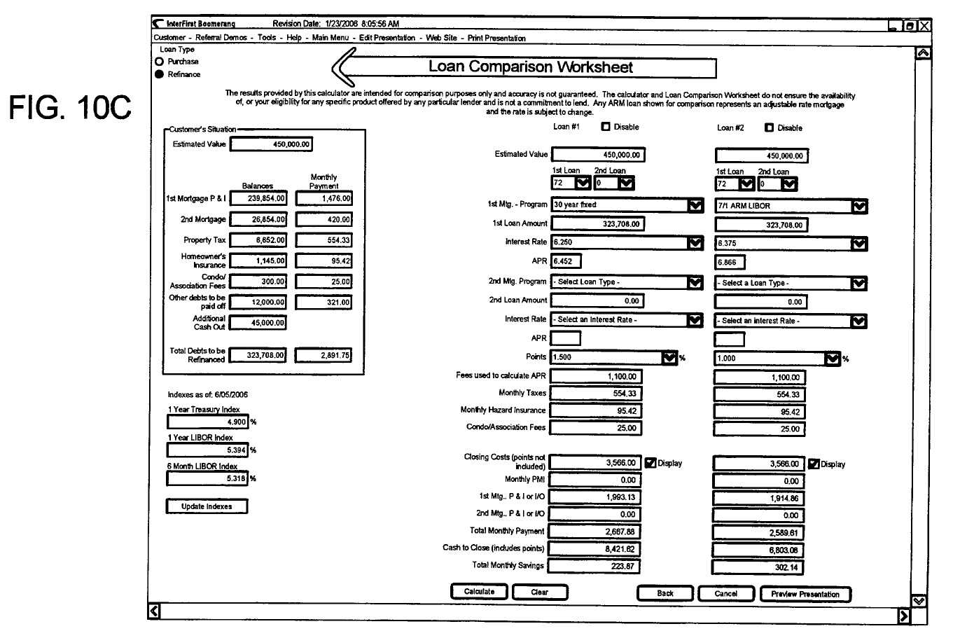

FIGS. 10A-10B illustrate embodiments of exemplary loan comparison worksheets that include the financial information, obligations and advantages associated with three potentials loans or mortgages. The loan comparison selection can be configured in any suitable manner. For example, this selection can be configured to allow the LO to add any loan they wish, where they can calculate and manually fill out all fields under the newly created loan. Additional features illustrative of this selection include: 1) the ability to disable PMI on individual loans, where LENDER PAID can appear in the PMI box in the consumer presentation; 2) costs to calculate APR on first and second mortgage; 3) APR on a second mortgage; 4) ability to change margins; 5) PREPAIDS; 6) add a buydown calculator; 7) provide history information, such as a drop down list including past loan comparisons; and 8) add a comments section to the worksheet that would display below the Details section on the web site, where this could explain, for example, the pros and cons of each option or explain the proposal.

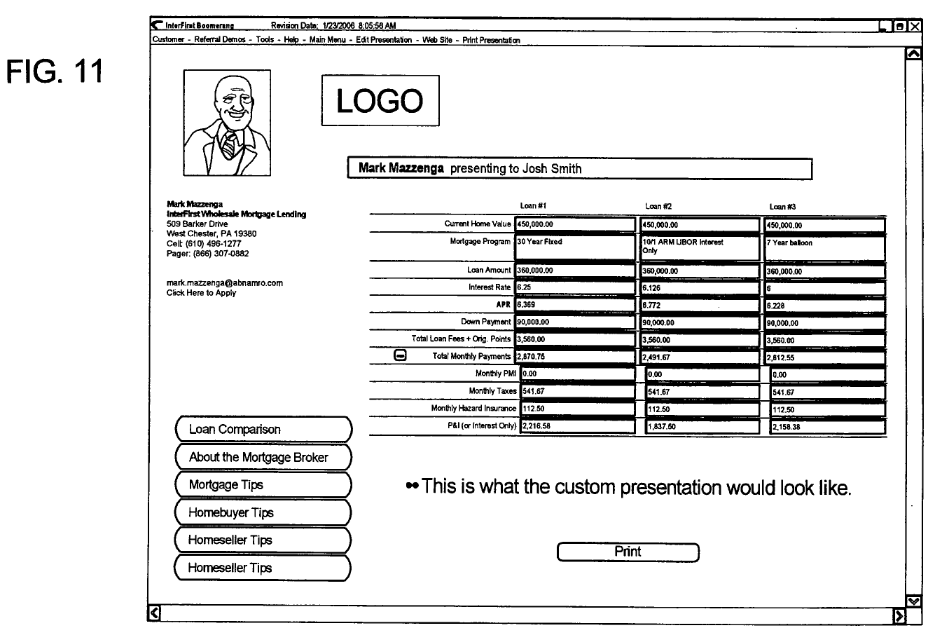

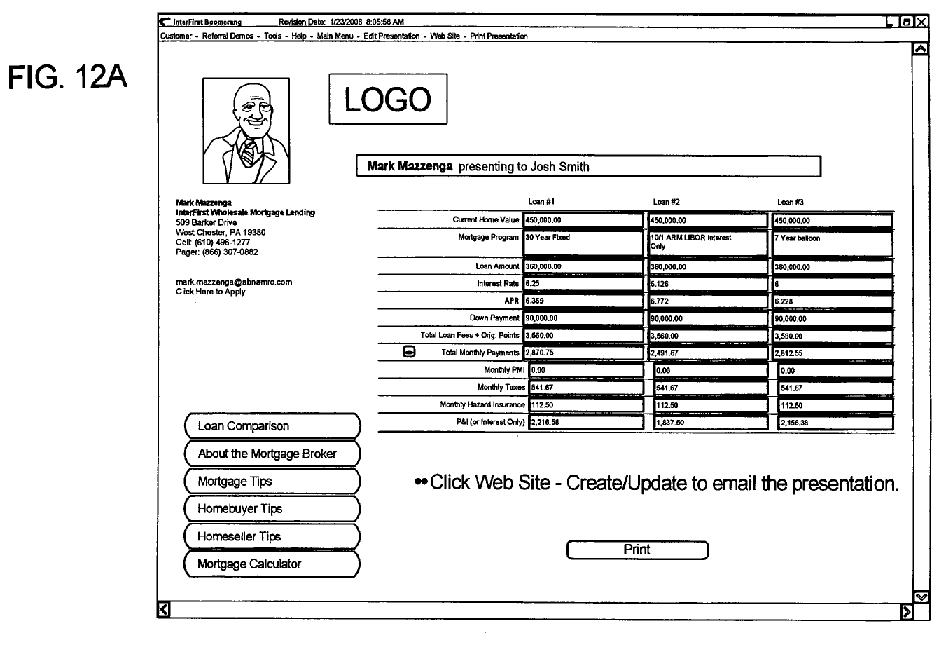

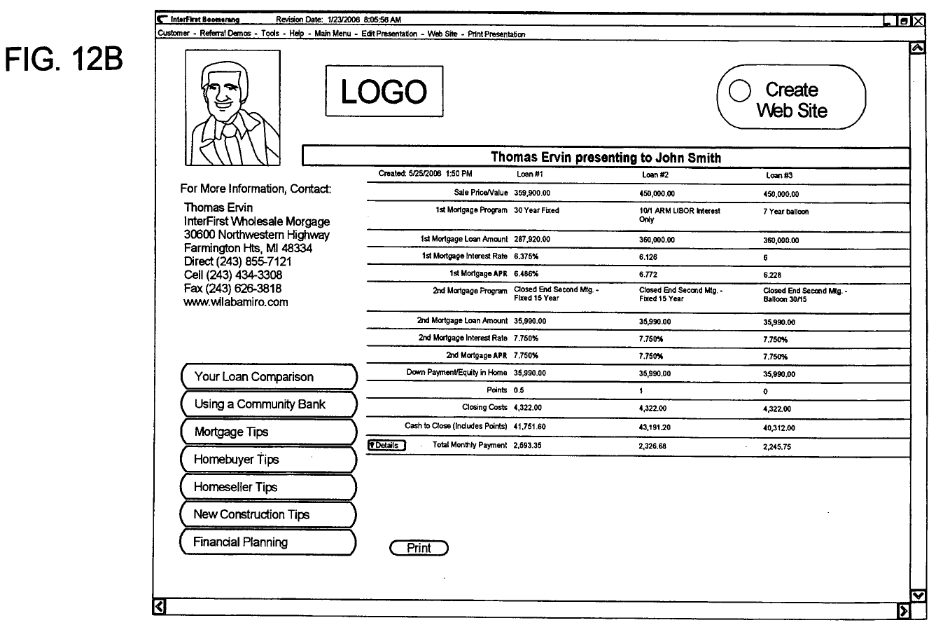

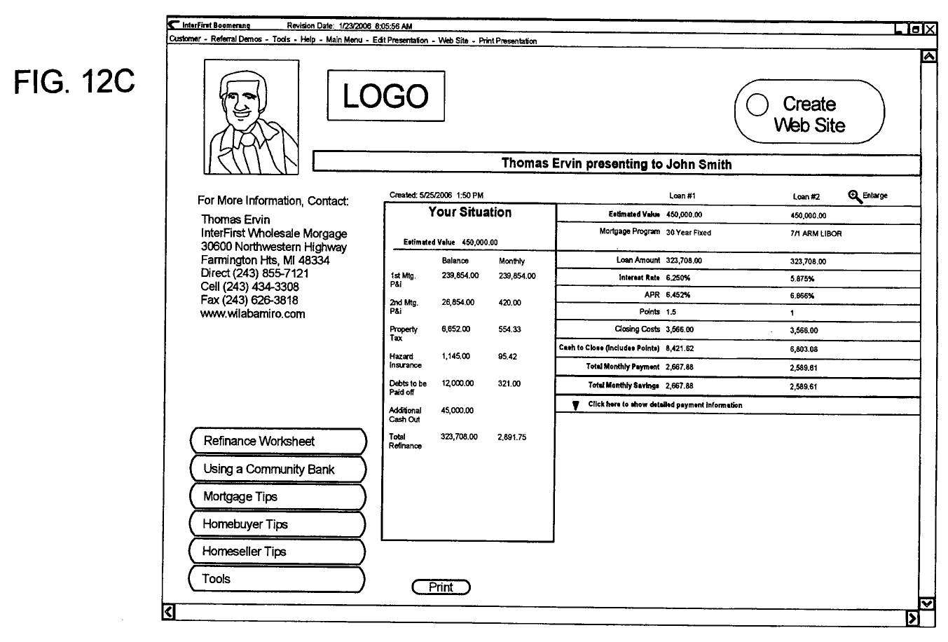

FIG. 10C illustrates a loan comparison worksheet associated with refinancing. The refinance section shows, for example, the borrower's current situation and compares it against two loan scenarios displaying total monthly savings, if applicable. FIG. 11 illustrates a customized view of the loan comparison worksheet formatted to include the LO's personal and business information. For example, this view includes an image of the LO, the corporate logo and the LO's contact information. FIGS. 12A- 12C are similar to FIG. 11, and illustrate the creation and/or update of the web site or client presentation that includes the customized loan and presentation information according to various embodiments.

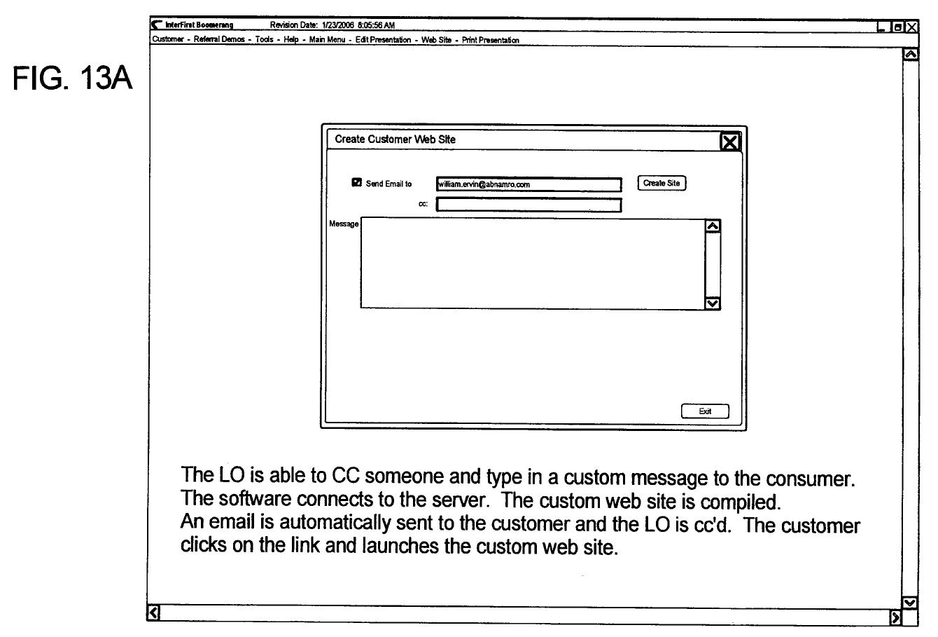

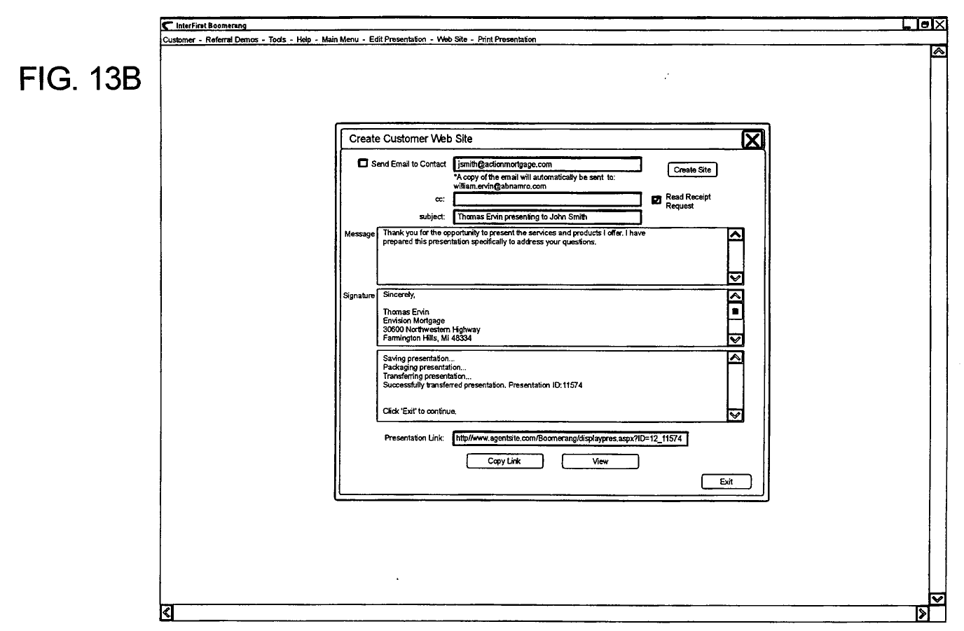

FIGS. 13A-13B illustrate how the LO is empowered to create personalized messages to client, carbon copy additional parties, associates, etc., with the information, and compile and upload the information via a web server to the web server.

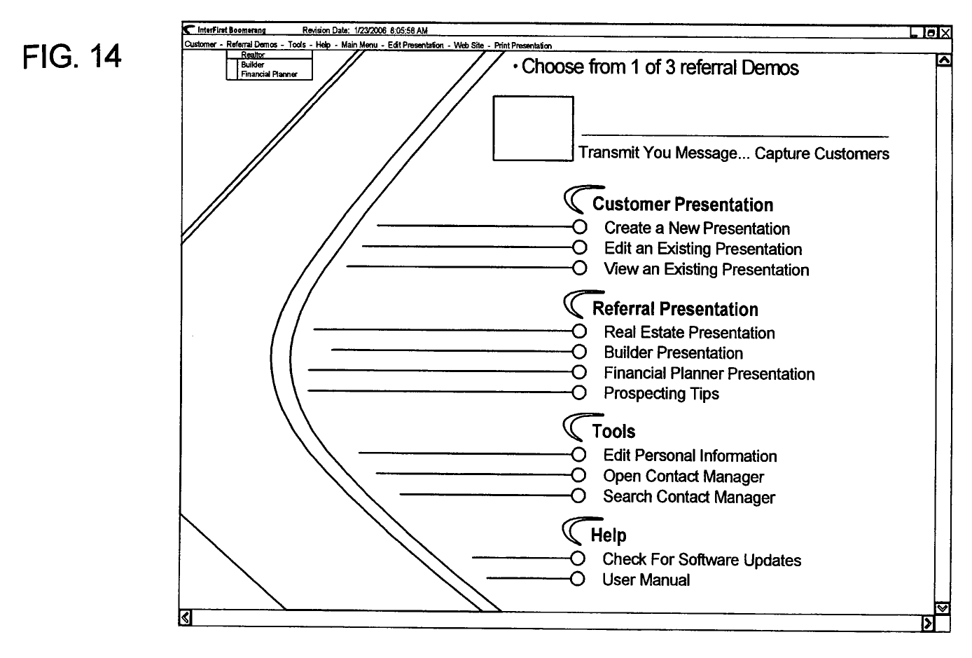

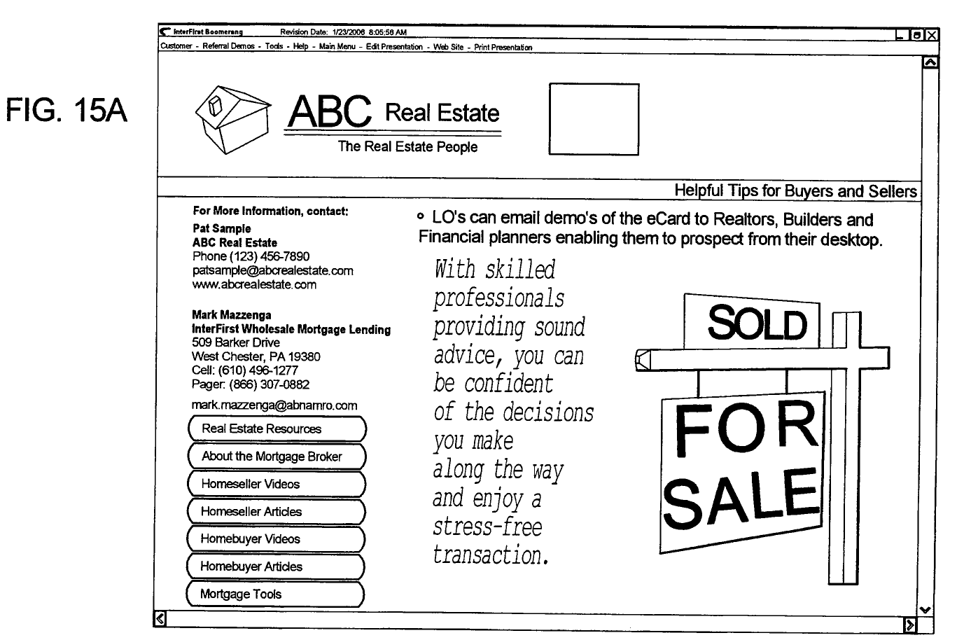

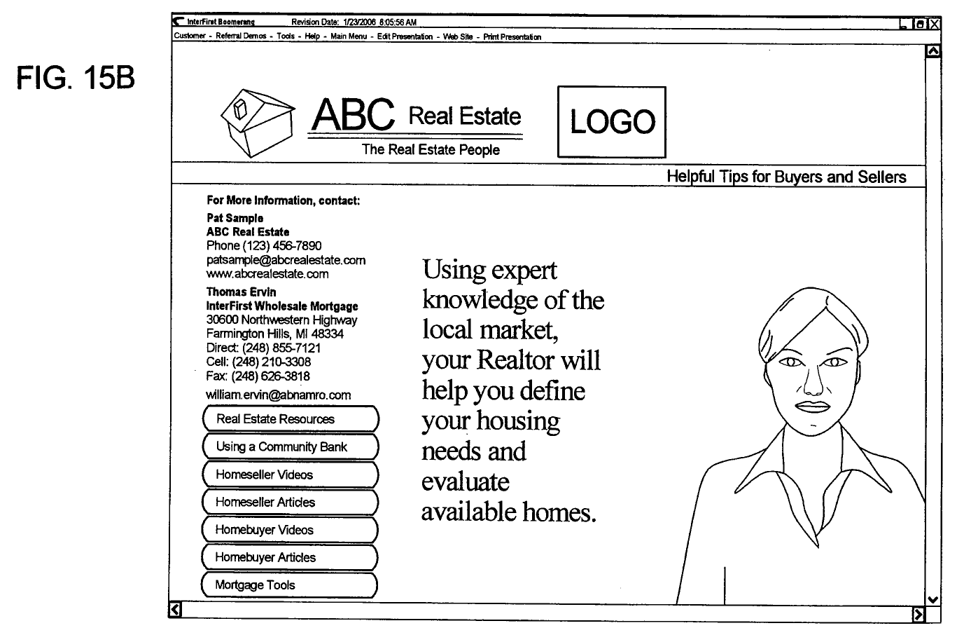

FIG. 14 illustrates an embodiment of the system utilized to create a presentation for a real estate agent. FIGS. 15A-15B illustrate customized views of a presentation page geared towards the real estate agent according to various embodiments. In particular, this type of customized page can include the LO's personal and business information, and the logo and/or information of the targeted referral source.

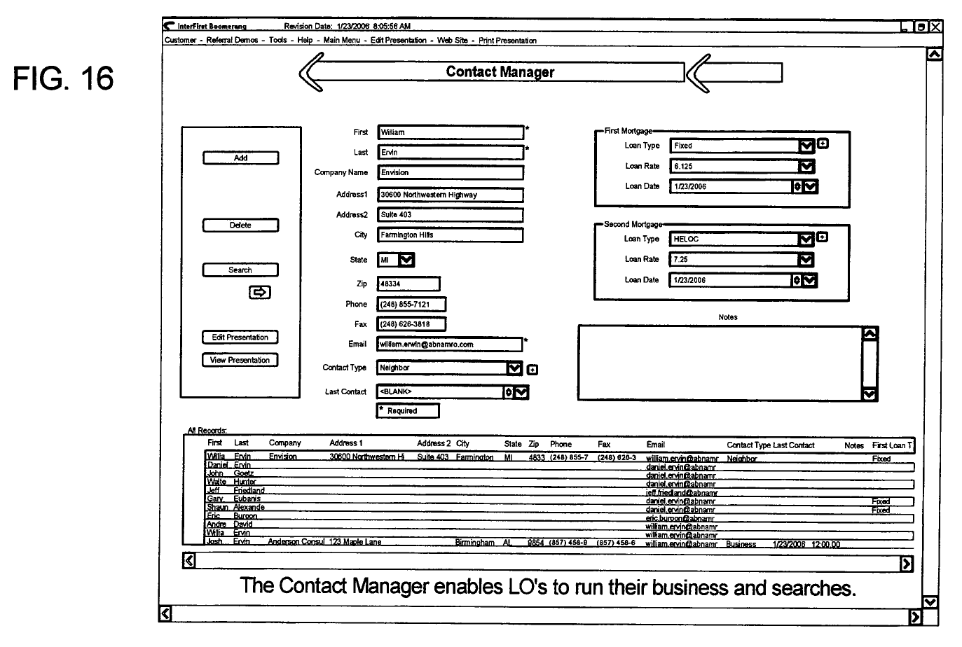

FIG. 16 illustrates another view of the contact manager and the included search and organization functionality.

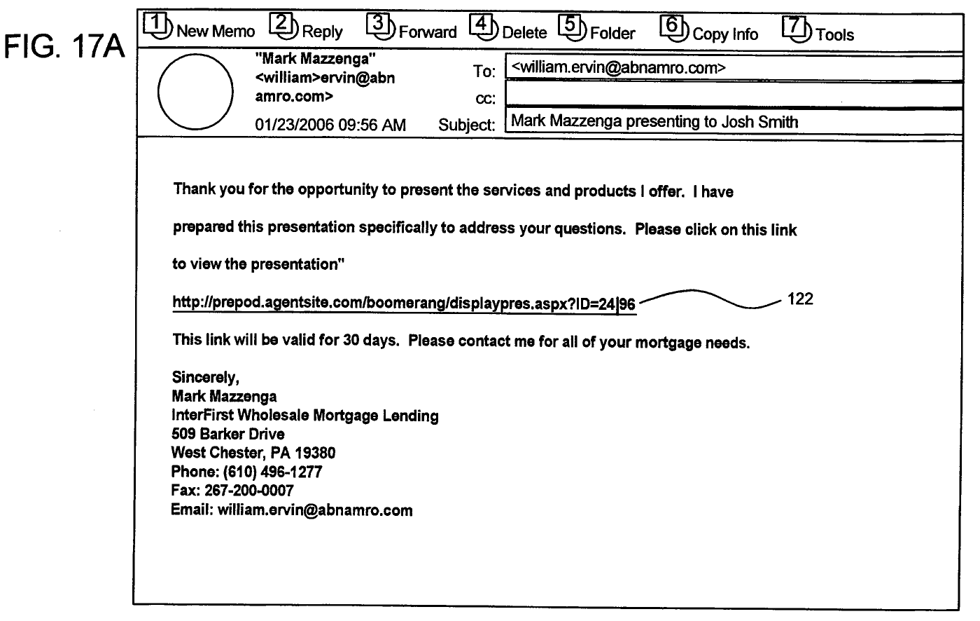

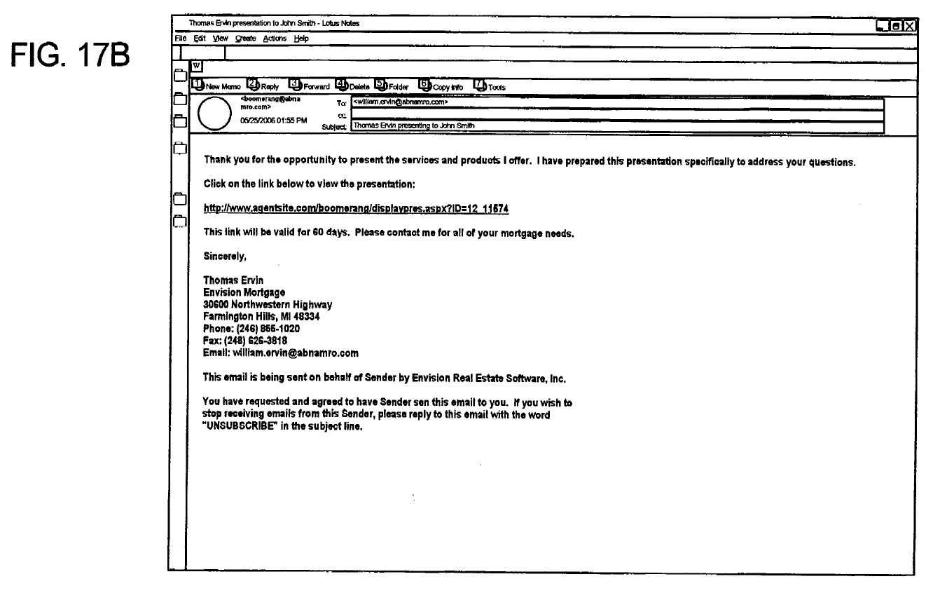

FIGS. 17A-17B illustrate various embodiments of the personalized message that can be communicated to the client/customer or referral source. In particular, this type of message can include personalized text, the hyperlink 122 leading to the client or referral presentation hosted on the web server and the LO's contact information.

It should be appreciated that the invention can be utilized in a number of different applications and modified in any suitable manner. For example, individual real estate agents can make web-based sales presentations to both home buyers and sellers. As with the loan officer application described above, individual web sites can be created with personalized information reflecting a prior interview conducted by the Realtor with his or her buyer or seller. These presentations can include, for example, FLASH movies with content similar to the loan officer version. The real estate version can also include, for example: 1) the ability to import current, sold and expired real estate listings from MLS services including all the features of each property; 2) a mapping feature which will locate each property retrieved from the MLS on a map; 3) a marketing plan showing how a listing will be marketed; and the like.

In another embodiment, individual builders and their sales representatives can make web-based sales presentations to new home buyers. As with the loan officer version described above, individual web sites can be created with personalized information reflecting a prior interview conducted by the builder and or the builder's sales representatives with a new home buyer. These presentations can include FLASH movies with content similar to the loan officer version. The builder version can also include, for example: 1) model home information; 2) customized option information; 3) subdivision maps; 4) home financing information; 5) additional customized FLASH movies of the builder's choosing; and the like.

Additional features can include, for example: 1) ability to set property tax as a formula or flat fee to account for different calculations in different state; 2) ability to co-brand the presentations with referral sources, thereby allowing LO's to pick from a referral list to add to outgoing presentations; 3) design a counter regarding how many hits a presentation web site receives; 4) remove or maintain the detail tab; 5) ability to toggle to either company movie or loan comparison first; 6) ability to send an automated WARNING MESSAGE to customer and LO three days before the web link expires; 7) create an array of e-mail messages that an LO can choose from when creating a web site and that would encourage borrowers to forward their presentation to someone else that could generate more leads for the LO; 8) create a spot where the LO can insert a picture of the home on the loan comparison worksheet thereby allowing set up of open house flyers to add more value to their realtor relationships; and 9) allow user to import contacts.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A system for providing client presentations, the system comprising:
a first computer, the first computer having a memory and a processor operatively coupled to the memory,
wherein the memory is configured to store a plurality of client information and a plurality of presentation information related to the client information; and
wherein the processor is configured to generate a client resource file based on the plurality of client information and the plurality of presentation information;
a second computer communicatively coupled to the first computer, the second computer configured to provide the client resource file and transmit a client link;
a third computer communicatively coupled to the second computer, the third computer configured to receive the client link, wherein the third computer displays the client resource file provided by the second computer in response to the client link.

2. The system of claim 1, wherein the a client resource file is an extensible mark-up language file.

3. The system of claim 1, wherein the client resource file is a hypertext mark-up language file.

4. The system of claim 3, wherein the second computer is a web server configured to host the hypertext mark-up language file.

5. The system of claim 1, wherein the client resource file generated on the first computer is a synchronized file that updates the client resource file provided by the second computer.

6. The system of claim 1, wherein the client link is an electronic mail communication.

7. The system of claim 6, wherein the electronic mail communication includes a hyperlink to a web page hosted by the second computer.

8. The system of claim 1, wherein the client resource file includes a plurality of user information.

9. The system of claim 1, wherein the plurality of presentation information includes one or more interactive media clips.

10. An apparatus for providing customizable client presentations, the apparatus comprising:
a processor;
a memory operatively coupled to the processor, the memory configured to store a client presentation program that includes:
a client information subroutine configured to receive client information and presentation information related to the client information;
a client presentation subroutine configured to generate a client resource file based on the client information and the presentation information;
a presentation subroutine configured to provide the client resource file; and
a communications subroutine configured to communicate a client link.

11. The apparatus of claim 10, wherein the memory includes:
a first memory at a first location; and
a second memory at a second location, the second memory communicatively coupled to the first memory;
wherein the first memory stores the client information subroutine and the client presentation subroutine, and the second memory stores the presentation subroutine and the communications subroutine.

12. The apparatus of claim 10, wherein the client resource file is an extensible mark-up language file.

13. The apparatus of claim 10, wherein the client resource file is a hypertext mark-up language file.

14. The apparatus of claim 11, wherein the client resource file is a hypertext mark-up language file.

15. The apparatus of claim 14, wherein the second memory is operatively coupled to a processor configured to operate as a web server to host the hypertext mark-up language file.

16. The apparatus of claim 10, wherein the communications subroutine communicates an electronic mail communication that includes the client link.

17. The apparatus of claim 10, wherein the client link is a hyperlink.

18. The apparatus of claim 10, wherein the client resource file includes a plurality of user information.

19. The system of claim 10, wherein the presentation information includes one or more interactive media clips.

20. A method of providing customizable client presentations, the method comprising:
gathering a plurality of client information;
selecting a plurality of presentation information related to the client information;
generating a client resource file based on the client information and the presentation information, the client resource file including a plurality of user information;
storing the client resource file;
generating a client website based on the client resource file; and
providing a multimedia interaction based on the generated client website.

21. The method of claim 20 further comprising:
storing the client website on a web server.

22. The method of claim 21 further comprising:
communicating a client link identifying the stored location of the client website on the web server.

23. The method of claim 22 further comprising:
presenting the client resource file in response to a request related to the client link.

24. The method of claim 20 further comprising:
updating the plurality of presentation information; and
regenerating the client resource file.

25. The method of claim 20, wherein gathering the plurality of information includes populating a contact database.

26. The method of claim 20, wherein generating the client resource file includes generating an extensible mark-up language file.

27. The method of claim 20, wherein storing the client resource file includes uploading the client resource file to the web server via an internet connection.

28. The method of claim 22, wherein communicating the client link includes providing a hyperlink.

29. The method of claim 22, wherein communicating the client link includes transmitting an electronic mail message.

30. A system for providing a customized presentation, the system comprising:
a first computer, the first computer having a memory and a processor operatively coupled to the memory,
wherein the memory is configured to store a plurality of user information;
wherein the memory is further configured to store a plurality of client information and a plurality of presentation information related to the client information; and
wherein the processor is configured to generate a client resource file based on the plurality of user information, plurality of client information, and the plurality of presentation information;
a second computer communicatively coupled to the first computer, wherein the second computer is configured to provide a client web page generated from the client resource file and transmit a client link to a third computer for displaying the client web page.

31. A method of providing a customized presentation to a client, the method comprising:
communicating remotely with a client;
gathering a plurality of client information;
selecting a plurality of presentation information related to the client information;
generating a client resource file based on the client information and the presentation information, the client resource file including a plurality of user information;
generating a client website based on the client resource file;
storing the client website on a web server;
communicating a client link identifying the stored location of the client website on the web server;
presenting the client website in response to a request related to the client link; and
providing a multimedia interaction based on the client website.
